(19) United States
(12) Patent Application Publication
(10) Pub. No.: US 2004/0057642 A1
(43) Pub. Date: Mar. 25, 2004

(54) Thrust bearing arrangement

(76) Inventor: Nigel Henry New, Middlesex (GB)

Correspondence Address: James A Wilke, Foley & Lardner, Suite 3800, 777 East Wisconsin Avenue, Milwaukee, WI, 53202-5306, US

(21) Appl. No.: 10/470,290

(22) PCT Filed: Feb. 4, 2002
(86) PCT No.: PCT/GB02/00459

(30) Foreign Application Priority Data
Feb. 2, 2001 (GB) 0102762.2

(51) Int. Cl. F16C 32/06

(52) U.S. Cl. 384/122

(57) ABSTRACT

A hydrodynamic thrust bearing arrangement for supporting a rotating machine shaft against axial thrust forces comprises a collar carried by the shaft with axially spaced, axially facing faces, one of which, say, bears against an array of bearing pads by way of an intervening lubricant film. The bearing pads may be faced with a polymer or other material which as a poor conductor of heat from the lubricant film which may permit the lubricant to overheat and the film to break down. To avoid this, the collar is made from a metal having a thermal conductivity greater than 150 W m⁻¹° k⁻¹ and with such collar thickness to withstand the bending stresses of the axial thrust forces, and the unloaded face is in contact with a coolant, typically the lubricant, which can transfer heat from the hydrodynamic film even when at ambient temperature. Cooper or aluminum alloys may be used.

This invention relates to rotating machines and in particular to thrust bearing arrangements for supporting rotating shafts of such machines in respect of thrust forces acting along their rotation axes.

Within a machine having a shaft rotating within a housing, it is known to provide a collar, extending radially of the shaft with at least one face that extends in the radial direction and faces along the axis of the shaft, and a plurality of bearing pads, carried by the housing as an annular array extending about the shaft and overlying a face of the collar such that axial loads on the shaft are transferred across the interface between collar face and pads, and to supply the interface with a liquid lubricant that develops a supporting film preventing physical contact between the parts. This face of the collar through which the thrust forces act is known, and described herein, as the “thrust face”.

The film is typically generated hydrodynamically by virtue of the relative movement between the collar and each bearing pad. As is well known, shearing of the liquid lubricant under load generates a significant amount of heat locally where the load is applied. This heat generation increases with surface speed and load and, insofar as the viscosity, or even stability, of most lubricants is temperature dependant, there is a risk of such a loaded film rupturing and permitting direct contact between the pads and collar if the temperature of the loaded film is permitted to rise uncontrollably.

In general such situation is avoided by conducting excess heat from the lubricant film by replacing the lubricant and by way of the bounding bearing pad and collar, heat is extracted partly by conductions through the bearing pads and collar.

It will be appreciated that such a thrust bearing arrangement frequently is required to support axial loading at separate times in both axial directions, that is, act bi-directionally and to this end the collar may be formed with oppositely axially facing faces, each of which has an overlying array of thrust bearing pads, notwithstanding that only one collar face is active as a thrust face at any instant, the other being then a non-active thrust face. Hereinafter in this specification the term “non-thrust face” is used to refer to both an instantaneously non-active thrust face of a bi-directional bearing arrangement as well as a face of a uni-directional bearing arrangement with no adjacent bearing pads.

Bearing arrangements as outlined above, whether arranged to function uni-directionally or bi-directionally, are hereafter considered to be “as herein defined”.

Whether such bearing arrangement is required to support axial loading uni-directionally or bi-directionally, it has to be accommodated within the machine housing and is generally optimised dimensionally. To this end, and insofar as the machine usually has a shaft of steel and load supported by the collar is displaced from the shaft and load forces on the collar act to deflect the collar relative to the shaft against its bending stiffness, a steel collar has in practice been a suitable compromise between cost, strength, thermal conductivity.

Other shaft materials are known when speed operating conditions make steel unsuitable. Bearing pads are usually formed of a metallic bearing alloy on a metallic backing piece which backing piece may be of a metal having good thermal conductivity.

It is also known to provide thrust bearing arrangements in which the bearing pads have a bearing surface of polymer material; often this is employed with water or water-based lubricant. However, it has been found that under larger levels of loading, heat generated locally within a lubricant film at the interface between such polymer faced pads and collar thrust face is not conducted away adequately by known materials and constructions. The relatively poor thermal conductivity of the polymer material coupled with the modest conductivity of the steel collar permits the temperature of the lubricant in the interface to rise to levels where the load bearing integrity of the film is compromised. However, improving the conduction of heat by way of the steel collar is subject to conflicting criteria, and facilitating improved conduction by changing the collar structure or other parts of the bearing arrangement, result in increased collar thickness and overall size and/or complexity of the bearing arrangement with significant economic consequences.

As heat flow through the collar is dependent upon the temperature difference between the thrust and non-thrust faces, it should be possible, if not practicable, to take steps to reduce the temperature of the non-thrust face by extracting heat therefrom into an environment of much lower temperature than the thrust face. However, for a steel collar typically having a thermal conductivity of about 40-50 W m⁻¹° k⁻¹, thickness of 1.5 cms to 5 cms and a potential film/thrust face temperature of 60 to 150° C. under a thrust face loading of 3MPa, then depending upon speed it can be expected that a steel collar as the sole means of extracting heat from the film would require running the non-thrust face at 40° C. Insofar as the housing in operation may typically have a temperature of 70° C. and the lubricant circulate at 50° C., such a requirement in effect demands a cooling of the supplied lubricant below the ambient temperature of the machine.

It will be appreciated that whilst there is a particular problem with such polymer faced bearing pads, pads faced with a metal or metal alloy that has a poor thermal conductivity, or indeed a low melting point, and for which local overheating of the lubricant film is detrimental may also share the same problem.

It is an object of the present invention to provide, for a machine including a rotatable shaft, a hydrodynamic lubricated thrust bearing arrangement which provides in simple and cost effective manner thermal control of lubricant film between collar face and bearing pads. It is also an object of the present invention to provide a machine including such bearing arrangement.

According to a first aspect of the present invention, for a machine including a shaft rotatable within a housing a hydrodynamic thrust bearing arrangement, for supporting the shaft with respect to forces acting in a direction along the longitudinal axis of the shaft, comprises (i) a collar extending radially from the shaft between oppositely axially directed first and second faces that define the thickness of the collar, a first of the faces comprising a thrust face facing in the direction of the thrust force and the second face comprising a non-thrust face, (ii) a ring of bearing pads disposed in an annular array extending about the shaft and mounted with respect to the housing such that a bearing surface of each pad faces axially in a direction opposite to the thrust force, each bearing pad of the ring having a bearing surface of the pad overlying the first face, and (iii) lubrication means, operable to supply a liquid lubricant to the interface between each pad bearing surface and the collar thrust face to form a hydrodynamic film of the lubricant therebetween upon rotation of the shaft and collar, and is characterised in that the collar is discrete from, and secured to, the shaft, the collar is formed of a metallic material having a thermal conductivity greater than 150 W m⁻¹° k⁻¹, and the lubrication means is operable to cause a temperature control liquid to flow in contact with the non-thrust face of the collar at a temperature and rate to establish at said non-thrust face a datum surface temperature related, by the thermal conductivity and thickness of the collar between the faces, to a thrust face temperature substantially at a value corresponding to a desired lubricant film temperature.

The bearing arrangement may respond to uni-directional or bi-directional thrust forces and may be of the directed lubrication or flooded lubrication type.

According to a second aspect of the present invention a machine including a shaft rotatable within a housing has a hydrodynamic thrust bearing arrangement as defined in one or both of the preceding two paragraphs.

Embodiments of the invention will now be described by way of example with reference to the accompanying drawings, in which

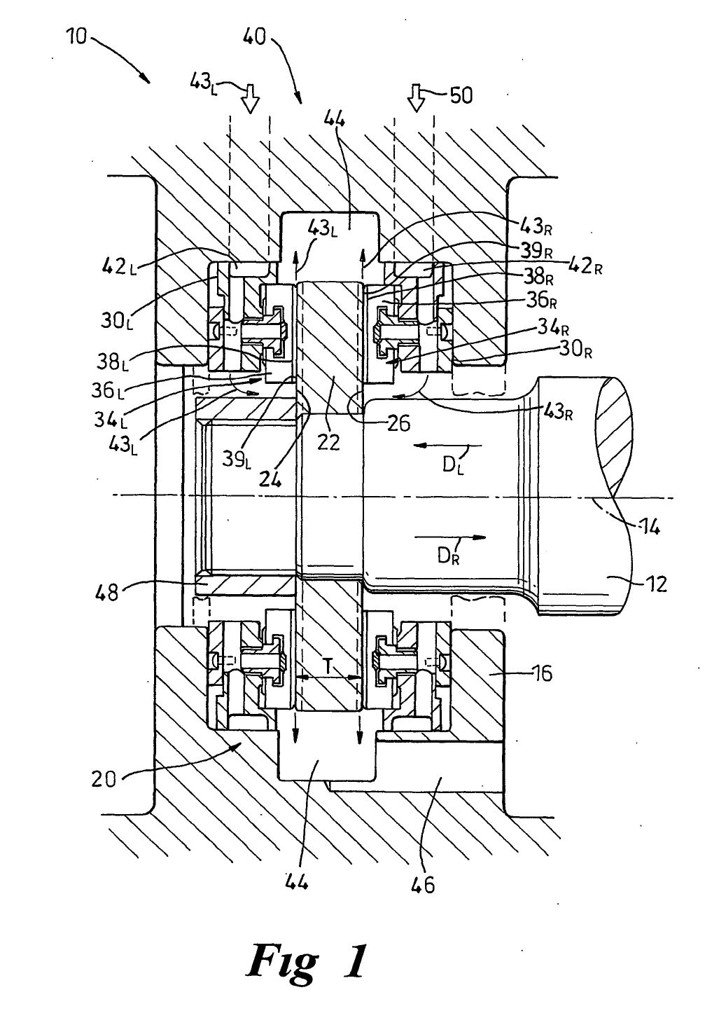

FIG. 1 is a sectional elevation through a first embodiment of machine and thrust bearing arrangement according to the present invention, in schematic form, illustrating a simple unitary collar, and directed lubrication of the bearing arrangement, and

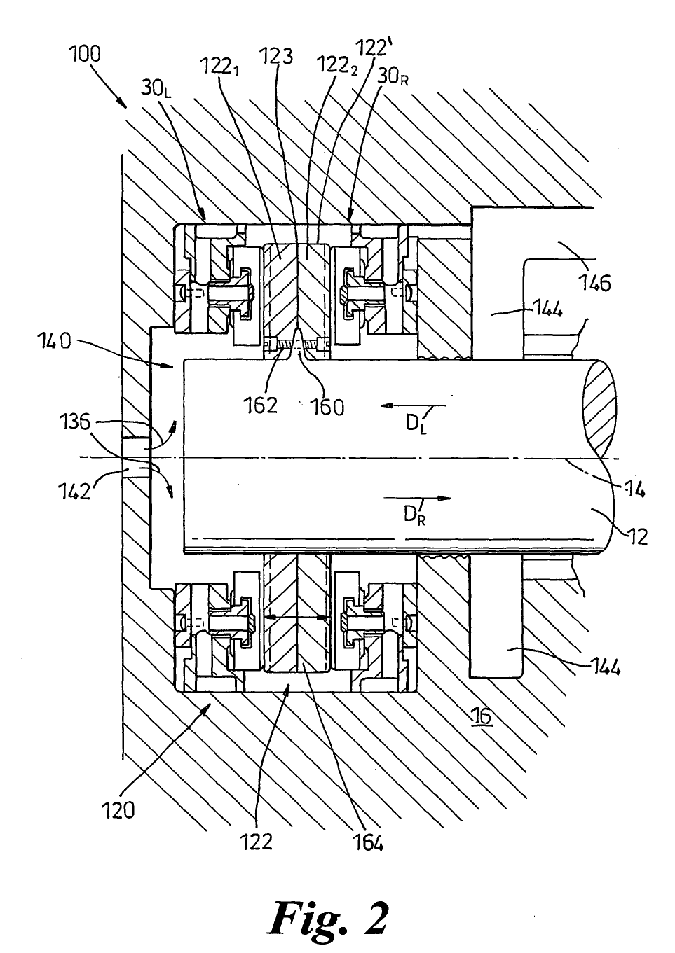

FIG. 2 is a sectional elevation through a second embodiment of machine and thrust bearing arrangement according to the present invention illustrating a composite collar and flooded lubrication of the bearing arrangement.

Referring to FIG. 1, a machine, indicated generally at 10, includes a conventional steel shaft 12, being part of a rotor and rotatable about a longitudinal axis 14 thereof within a housing 16. The shaft is supported in respect of forces acting radially with respect to the longitudinal axis by a conventional journal bearing arrangement (not shown) and in respect of forces acting in a direction along the longitudinal axis by thrust bearing arrangement 20.

The thrust bearing arrangement 20 is arranged to support the shaft bi-directionally in respect of forces acting from right to left in the Figure, denoted by arrow D_{L} and forces acting oppositely, from left to right as denoted by arrow D_{R}. For the purposes of explanation, the arrangement will be considered primarily in respect to thrust forces acting in the direction D_{L}.

The thrust bearing arrangement 20 comprises a collar 22, in the form of an annular body of metal, extending radially from the shaft 12 between oppositely axially directed first and second faces, 24 and 26 respectively, that define the thickness T of the collar. In respect of thrust forces in direction D_{L} the first face 24 comprises a thrust face and the second face 26 comprises a non-thrust face.

An annular carrier ring 30_{L} is mounted in the housing and carries an array of bearing pads 34_{L}, the array extending about the shaft. Each bearing pad comprises a metal body 36_{L} pivotally mounted with respect to the ring and a bearing surface 38_{L}, the ring of bearing pads being disposed such that the bearing surface of each pad overlies the first face 24 of the collar and defines an interface 39_{L} between them.

Lubrication means, indicated generally at 40, pumps lubricating oil at elevated pressure into the housing by way of supply duct 42_{L}. The lubricant passes, as denoted by arrow 43_{L}, through each pad mount towards the shaft and thereafter flows over the first face 24 of the collar, including passing through the interface 39_{L} to prevent physical contact between the pad bearing surface and the collar face. Lubricant leaving the interface region, or surface of collar, passes into a collection region 44 from which it drains by way of drain duct 46.

Upon rotation of the shaft and its attached collar, the lubricant at the interface with each bearing pad effects a hydrodynamic load bearing film that supports the collar, subjected to axial forces in direction D_{L}, clear of the bearing pads.

Between the relatively moving surfaces of bearing pads and collar, the lubricant is subject to shearing which generates heat that is dissipated both by the flow of lubricant that replenishes and replaces the film and by conduction through the adjacent collar and bearing pad.

In this embodiment a second annular carrier ring 30_{R} of bearing pads 34_{R} is also mounted in the housing with the pads 34_{R} arrayed about the shaft such that bearing surface 38_{R} of each faces towards, and overlies, the second face 26 of the collar, defining an interface 39_{R} between them. The lubrication means also includes a supply duct 42_{R} and pumps lubricant (denoted by arrows 43_{R}) through the bearing carrier ring towards the shaft so that the lubricant flows over the second face 26 of the collar to the collection means 44. Insofar as the bearing surfaces 38_{R} of the bearing pads overlie the second face, the lubricant also flows through the interfaces 39_{R} between the collar and bearing surfaces. When an axial force acts on the shaft in a direction D_{R}, then any end float of the shaft permits the collar to move towards the bearing pads 34_{R}, whereupon the relative motion between the collar second face and the bearing pad surfaces and hydrodynamically forms a load-supporting film that prevents direct contact between the bearing surfaces and collar face.

However, when an axial force acts on the shaft in direction D_{L} as is being considered, the collar second face 26 defines a non-thrust face which overlies, but does not transmit forces to, the bearing pads 34_{R}. To this end, the interface gap between the second (non-thrust) face and any bearing pads 34_{R} is not under load and the lubricant moves therethrough readily and without forming a highly sheared load-bearing film, but nevertheless is constrained to flow between the interface at an accelerated rate that is determined by the rotation speed of the collar and be subjected to turbulence at the collar face surface, both of which increase the efficiency of heat transfer between the collar and liquid.

The form of thrust bearing arrangement described above is known as a directed lubrication type, that is, the liquid lubricant is directed to flow across the first and second faces of the collar in contact therewith and then from the housing.

The bearing surface 38_{L} (or 38_{R}) of each pad is formed from a layer of polymer material overlying the body and as such has a poor thermal conductivity in terms of conducting heat from loaded lubricant film.

The collar 22 is discrete from, and secured to, the shaft by nut 48 and comprises an annular body of a metal having a thermal conductivity greater than 150 W m⁻¹° k⁻¹. The collar thickness T is sufficient, having regard to its radius and distance from the axis at which forces are transmitted to the housing by way of the pads, to give it the strength and stiffness to support the loading exerted thereon by the maximum thrust force for which the bearing is designed. In this embodiment the collar is formed of commercially pure copper, which has a thermal conductivity of about 380 W m⁻¹° k⁻¹, and an elastic modulus that requires a thickness T about 12% greater than would be required of a traditional solid steel collar to give the same degree of bending stiffness.

In operation, the lubrication means supplies lubricant by way of duct 42_{L} to flow past bearing pads 34_{L} and first, thrust face 24 of the collar, forming therebetween a load-bearing film in conventional manner. Insofar on the load-bearing capability of the lubricant is temperature dependent, which capability may fail if the temperature rises above an upper limiting value or falls below a lower limiting value, it is possible to determine one or more desirable or limiting temperature values for the film adjacent the thrust face 24. The minimal thickness of the film, high relative surface speed which prevents boundary stagnation of the film, and good thermal conductivity of the collar material, ensures that the surface temperatures of the first face and the film track each other with little, if any, discrepancy.

Therefore, it follows that extraction of heat from the first face by way of the second face at the same rate that it is generated within the lubricant can prevent the temperature of the first face and lubricant from rising uncontrollably. Also, insofar as such heat extraction rate is dependent upon the temperature difference between the first and second faces, then having regard to the conductivity of the collar material, its thickness and a desired operating temperature of the first face under load which may be limiting or optimal, a datum temperature may be defined for the second, non-thrust face 26 that corresponds to such rate of heat flow between them and in turn defines the temperature of the first face, provided heat is extracted from the second face at the same rate as it enters the first face and tracks changes thereof.

The lubrication means 40 is also arranged to pump a temperature control liquid, indicated generally at 50, through inlet duct 42_{R} and into contact with the second, non-thrust face 26 of the collar and thereacross to the collection region 44, including flowing through the interface 39_{R} between the collar second face and the bearing pads 34_{R}. The temperature control liquid conveniently, but not necessarily, comprises the lubricant 43_{R}, and is caused to flow in contact with the collar second face 26 at such temperature and flow rate that the face adopts a said datum temperature.

Because the collar has good thermal conductivity, heat may flow at a suitable rate with little temperature difference between the faces 24 and 26, which means that the liquid may be substantially at ambient temperature with respect to the lubricant circulating in the machine and changes of temperature at one face are more rapidly reproduced at the other face. Looked at another way, the temperature of the first face is effectively clamped with respect to the second face if the datum temperature is maintained constant. However, if the first face/lubricant film temperature is kept away from limiting value, there is considerable variation possible in the datum temperature, and a suitable temperature may be defined by simple circulation of the lubricant without imposing strict conditions of temperature and/or delivering thereon.

As indicated above, the collar thickness is determined by the stiffness required of it and is thicker than its steel counterpart, but the required flow of heat therethrough is still achieved with a temperature difference between the faces that is less than would be required to extract such heat through a steel collar of similar load bearing strength to maintain a desired film temperature. For example, the thermal conductivity of copper is approximately ten times that of steel, so that notwithstanding a collar of 12% greater thickness, the temperature difference between the faces of such a collar is still only 11% of that for a steel collar for the same thermal flux. Furthermore, such a conductive collar is also more responsive to changes than prior arrangements in which a steel collar and thermally coupled steel shaft tend to resist the flow of heat generated by the lubricant film, rather than to extract it through the other face.

It will be appreciated that the temperature control liquid 50, when the lubricant 43_{R}, may be derived from the same source as that forming the film at the (active) thrust face and may be delivered at a rate and/or temperature, or may be treated differently to maintain/provide a desired datum temperature at the non-thrust face.

Such a source of temperature control liquid is particularly convenient for the bi-directional bearing shown, wherein the collar faces 24 and 26 and the lubricant inlet ducts 42_{L} and 42_{R} exchange roles in dependance on the axial thrust force direction D_{L} or D_{R}.

However, it will be understood that the lubrication means may similarly provide liquid, lubricant 43_{R} or otherwise, specifically to flow against the non-thrust face of a uni-directional bearing arrangement. In such a case there is greater flexibility in the form of temperature control liquid and how it flows; for example it may impinge on the non-thrust face as a spray.

Even with such bi-directional bearing structure, the temperature control liquid may be pumped at a different rate and/or temperature than the lubricant, provided that suitable control valves (not shown) are provided to exchange liquids with thrust force direction, and may differ from the lubricant with the provision of separate collection regions.

It will be appreciated that whereas in general the temperature control liquid will be at such a temperature as to extract heat from the load bearing lubricant film, there may be situations of low ambient temperature or during start up where it is desired to increase the temperature of the lubricant film by transferring heat from a (high) datum temperature non-thrust surface to the thrust face.

Also, and irrespective of the nature of the temperature control liquid and of the direction of heat transfer through the collar, the lubrication means may include a temperature sensor at the thrust face to continuously monitor the working temperature thereof and actively and continuously vary the temperature and/or supply rate of the control liquid in accordance with a predetermined program of desired temperature.

As mentioned above, the provision of lubricant separately to each face of a bearing is known as directed lubrication, but it is also common in thrust bearing arrangements to have the whole collar immersed in a flow of such lubricant, usually referred to as flooded lubrication.

Referring now to FIG. 2, this shows in similar sectional elevation to FIG. 1, a machine 100 and a thrust bearing arrangement 120 which are generally similar to the arrangements 10 and 20 with corresponding parts numbered identically and not described again. Where the bearing arrangement 120 differs is in respect of lubrication means 140 which comprises a single inlet duct 142 and collection region 144 leading to drain 146. Liquid lubricant 136 pumped into the housing at 142 floods the housing to drain 146 and completely immerses the collar 122 and rings of bearing pads 30_{L} and 30_{R}.

Instead of lubricant being pumped and directed to flow over the collar faces it tends to recirculate through the bearing pad carrier and flow over the rotating collar faces by centrifugal effect.

Operation is essentially as described above except that the temperature control liquid supplied to the non-thrust face of the collar is the lubricant 136 and at the same temperature as the bulk of the lubricant within the housing.

There are pros and cons for such lubrication form. On the one hand there may be significant energy loss by viscous drag of the collar through the liquid lubricant, but on the other hand more of the collar surface is exposed to the temperature control liquid, particularly the axially and circumferentially extending periphery 122′.

However, as discussed above, the conductivity of the collar permits a suitable lubricant film/thrust face temperature to b achieved with only a small temperature gradient through the collar and thus with the non-thrust and any other face exposed to the lubricant at temperature that is essentially ambient for the circulating lubricant.

A further difference illustrated here, but equally applicable to embodiment 10, is that the collar 122 comprises a pair of annular sections 122₁, and 122₂ of half collar thickness secured to each other at a radially extending interface 123 and enclosing a framework 160 integral with the shaft, for example by axially extending bolts 162. Such arrangement presumes that access is available for the annular sections along the shaft.

It is possible to provide at the mating surfaces of such collar sections, channels which define radial passages through the assembled collar, as shown ghosted at 164, and provide in effect, circumferentially discrete and restricted regions of reduced collar thickness in terms of heat flow from the thrust face defined by the passage surface at which a datum temperature can be defined by temperature control liquid passed therethrough. It is possible to provide such passages without significantly affecting the stiffness of the collar, and to this end it is possible to machine such passages into the solid collar described hereinbefore, although the extra cost of manufacturing the collar and supplying temperature control liquid to such passages may not be justified by the improvement in performance over and above the inherently improved heat flow between the first and second faces of a solid annular collar.

Altermatively or additionally to a collar of axially discrete sections, and not specifically illustrated, a collar 22 or 122 may be formed from circumferentially incomplete segments which are secured to the shaft and to each other about the shaft.

Although copper is a good thermal conductor for this use, and exhibits sufficient strength and stiffness to support the thrust forces by means of a simple collar being only some 12% thicker than a corresponding solid steel one, it is a soft material that is easily damaged by contaminants in the lubricant or temperature control liquid if different. To this end one or both of the collar faces may have deposited thereon an abrasion-resistant layer of a harder and less easily damaged material, such as hard chrome or an alternative commonly used to protect such soft metal. Notwithstanding that such material will have a lower thermal conductivity than the copper material forming the bulk of the collar, it may (in the case of hard chrome) be typically present as a thin layer of about 0.01 cms which does not decrease the overall conductivity of the collar significantly.

As an alternative to forming such collar 22 or 122 of substantially commercially pure copper, it may be formed of an alloy based on copper, or other suitable metal, but still have a thermal conductivity which is significantly greater than steel. For example, a copper-chromium alloy may be used, such as Cu-2% Cr, which has a thermal conductivity of 250-300 W m⁻¹° k⁻¹. Such an alloy of copper (or other metal) may be harder than the metallic copper but may also benefit from a wear-resisting surface layer of hard chrome, or the like. Alloys of aluminium may also be appropriate for forming the collar 22 or 122, and in such case an abrasion resistance of one or both collar faces may be provided by anodising the surface to give such layer, although metallic material could be applied to the surface.

Although such materials as commercially pure copper and copper-chrome alloy, with and without wear resistant surface plating, have been employed elsewhere in bearing structures as one of a pair of juxtaposed surfaces because of their thermal properties, this is invariably as a substrate or support for weaker bearing face materials. However, as the presently claimed invention demonstrates, it is practicable to provide a simple load-bearing collar which, with only marginal increase in dimensions, can provide control of lubricant film temperature without significant complexity.

1. For a machine (10, 100) including a shaft (12) rotatable within a housing (16), a hydrodynamic thrust bearing arrangement (20, 120) for supporting the shaft with respect to forces acting in a direction (D_{L}) along the longitudinal axis (14) of the shaft, the bearing arrangement comprising
(i) a collar (22, 122) extending radially from the shaft between oppositely axially directed first and second faces (24, 26) that define the thickness of the collar, a first of the faces (24) comprising a thrust face (26) facing in the direction of the thrust force and the second face comprising a non-thrust face,
(ii) a ring of bearing pads (34_{L}) disposed in an annular array extending about the shaft and mounted with respect to the housing such that a bearing surface (38_{L}) of each pad faces axially in a direction opposite to the thrust force, each bearing pad of the ring having a bearing surface of the pad overlying the first face (24), and
(iii) lubrication means (40, 140), operable to supply a liquid lubricant (43_{L}, 136) to the interface (39_{L}) between each pad bearing surface and the collar thrust face to form a hydrodynamic film of the lubricant therebetween upon rotation of the shaft and collar, and characterised in that
the collar is discrete from, and secured to, the shaft,
the collar is formed of a metallic material having a thermal conductivity greater than 150 W m⁻¹° k⁻¹ and the lubrication means is operable to cause a temperature control liquid (50, 136) to flow in contact with the non-thrust face of the collar at a temperature and rate to establish at said non-thrust face (26) a datum surface temperature related, by the thermal conductivity and thickness of the collar between the faces, to a thrust face temperature substantially at a value corresponding to a desired lubricant film temperature.

2. A thrust bearing arrangement as claimed in claim 1 in which the control liquid (50) caused to flow in contact with the non-thrust face of the collar is the liquid lubricant (43_{R}).

3. A thrust bearing arrangement as claimed in claim 1 or claim 2 in which the collar (122) has a peripheral face (122′) extending between the thrust and non-thrust faces and the lubrication means (140) is operable to cause said control liquid also to flow in contact with the peripheral face.

4. A thrust bearing arrangement as claimed in claim 3 in which the collar (122) is substantially immersed in said liquid.

5. A thrust bearing arrangement as claimed in any one of the preceding claims in which the lubrication means (40, 140) includes control means operable to define the temperature of the control liquid.

6. A thrust bearing arrangement as claimed in any one of the preceding claims in which the collar (20, 120) comprises a commercially pure copper.

7. A thrust bearing arrangement as claimed in claims 1 to 5 in which the collar (20, 120) comprises a copper-based alloy.

8. A thrust bearing arrangement as claimed in claim 7 in which the copper-based alloy is copper-chromium.

9. A thrust bearing arrangement as claimed in claims 1 to 5 in which the collar (20, 120) comprises an aluminium based alloy.

10. A thrust bearing arrangement as claimed in any one of the preceding claims in which at least the thrust face (24) of the collar is provided with a coating of abrasion resistant material.

11. A thrust bearing arrangement as claimed in claim 10 in which the abrasion resistant material is a thermally conductive metallic material.

12. A thrust bearing arrangement as claimed in claim 11 in which the material is hard chrome.

13. A thrust bearing arrangement as claimed in any one of the preceding claims in which the collar (22) is a unitary body of said metallic material.

14. A thrust bearing arrangement as claimed in any one of claims 1 to 12 in which the collar (122) comprises a plurality of sections (122₁, 122₂) of said metallic material secured to each other.

15. A thrust bearing arrangement as claimed in claim 14 in which said sections are secured to each other about a framework (160) integral with the shaft.

16. A thrust bearing arrangement as claimed in any one of the preceding claims arranged to support a said shaft with respect also to forces acting in an opposite direction (D_{R}) along the longitudinal axis of the shaft, comprising a second ring of bearing pads (34_{R}) disposed in an annular array extending about the shaft and mounted with respect to the housing such that a bearing surface (38_{R}) of each pad faces axially overlying the second face (26) of the collar and the lubrication means (40, 140) is arranged to supply the control liquid to the operationally non-thrust face of the collar.

17. A machine (10, 100) including a shaft (12) rotatable within a housing and a hydrodynamic thrust bearing arrangement (20, 120) as claimed in any one of the preceding claims.
